(19) United States
(12) Patent Application Publication
(10) Pub. No.: US 2009/0032183 A1
(43) Pub. Date: Feb. 5, 2009

(54) RADIO FREQUENCY WELDING

(75) Inventors: Leslie Gilligan, Lancashire (GB); Craig Miles, Lancashire (GB); Grayam Miles, Lancashire (GB); Alan Burke, Lancashire (GB)

Correspondence Address: BROOKS KUSHMAN P.C., 1000 TOWN CENTER, TWENTY-SECOND FLOOR, SOUTHFIELD, MI, 48075, US

(73) Assignee: BMG DESIGNS LIMITED, Burnley, Lancashire (GB)

(21) Appl. No.: 12/282,428

(22) PCT Filed: Mar. 9, 2007
(86) PCT No.: PCT/GB2007/000828

§ 371 Date: Sep. 10, 2008

(30) Foreign Application Priority Data
Mar. 14, 2006 (GB) 0605096.7

(51) Int. Cl. B32B 38/10; B32B 37/06

(52) U.S. Cl. 156/267; 156/379.6; 156/380.6; 156/274.4

(57) ABSTRACT

Disclosed is a mandrel for use in Radio Frequency welding, wherein the mandrel comprises first and second conductive portions separated by an insulating material, such that different potentials may be applied to the first and second conductive portions. Also disclosed is a method of RF welding and a method of manufacturing a mandrel.

The present invention relates to an improved device and method associated with Radio Frequency (RF) welding (also known as Dielectric or High Frequency (HF) welding).

RF welding is a technique used to weld or fuse materials together by the application of RF energy to the area to be joined. The resulting weld is very strong and can be as strong as the original material. The resulting seam can be impervious to fluids. The seal is able to be made consistent and uniform in appearance and dimensions.

The types of material which may be RF welded include a variety of different plastics material, including PVC, EVA, Saran and polyurethane.

Typically, the process of welding includes subjecting the parts to be joined to a High Frequency (HF) electromagnetic (EM) field, which is normally applied between two metal bars or electrodes. Typically, the HF signal applied to the parts to be joined is in the range 13-100 MHz. The electrodes also act as pressure applicators during heating and cooling.

The applied EM field causes the molecules in the material to be joined to oscillate and, depending on their geometry and dipole moment, these molecules may translate some of this oscillatory motion into thermal energy which causes localised heating of the material in the immediate vicinity of the applied field.

The area of medical devices is one particular area where the benefits of RF welding may be enjoyed. Bags for use with intravenous (IV) fluids, chemotherapy, blood, enteral feeding, ostomy, urology, laparoscopy, enema, ileostomy and fluid filtering are all produced using RF welding techniques. RF welding is also used to produce blood-pressure cuffs, hot and cold packs, leg compression sleeves, aircasts, body bags, wheelchair pads, immobilising pillows, breather bags, implants, IV arm boards, stretchers, centrifuge devices, sterilisation indicators, tourniquets, catheters and fluid pump cassettes, along with a great many disposable devices.

Furthermore, other areas, besides medicine and surgery benefit from devices constructed using RF welding techniques. Examples include: stationery (e.g. book covers, binders); inflatable novelty items (e.g. beach balls, airbeds); safety equipment (e.g. life rafts, life jackets); household items (e.g. upholstery for seating, table mats); automotive items (e.g. air bags, sun visors); packaging (e.g. prefabricated vacuum-formed blister material).

Although the preceding lists include a great many different types of devices, the technique used to seal them is essentially the same in each case. The method and apparatus known from the prior art is described briefly below.

The RF welding apparatus typically comprises an RF source (or generator) and an air-operated press that opens and closes the power applicator. The air-operated, or pneumatic press brings together the materials to be welded. In some cases, a simpler pedal-operated press may be used.

The RF generator comprises three main functional parts: a power supply; an oscillator; and a controller. The power supply is operable to convert an Alternating Current (AC) power supply to high-voltage (HV) Direct Current (DC). The oscillator acts to convert the HV DC signal into an AC signal at a particular voltage. Typically, the oscillator produces an output signal at 27.12 MHz (+/−0.6%) at a level of 1000 to 1500V. Other frequencies and output voltages are also used.

The controller is operable to regulate the output of the oscillator as the plastics material to be welded is heated. The controller is able to vary one or both of output power and duration of weld operation to achieve the desired result.

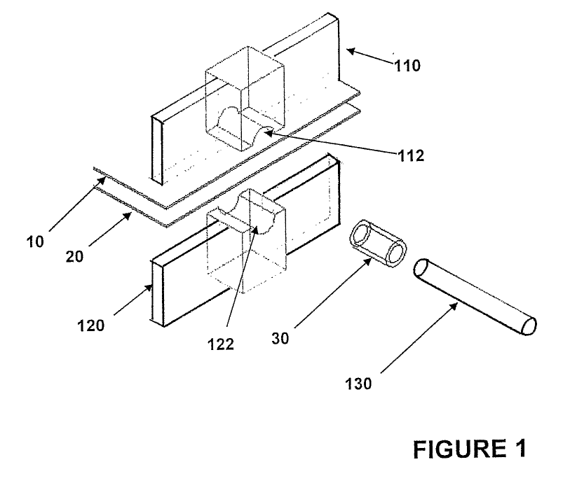

FIG. 1 shows a prior art arrangement used to seal two layers of plastics material film. The particular arrangement shown in FIG. 1 also shows how an extruded tube may be incorporated. The tube may be provided to allow a fluid to be introduced to, or emptied from, a bag formed from the two layers of plastics material, for instance. Such a bag may be a colostomy bag, for example.

The upper layer 10 and lower layer 20 of plastics material are placed into a press, which incorporates an upper electrode 110 and lower electrode 120. Since the electrodes in this particular arrangement are required to seal a tube 30 between the two layers 10, 20 of plastics material, the electrodes 110, 120 are each provided with a recess 112, 122 shaped and dimensioned to accommodate a tube 30.

The process for producing a weld in a device as shown in FIG. 1 is known as double-cycle tooling. The first cycle is used to seal the bag perimeter as well as the top half of the tube 30 to upper layer 10. The second cycle seals the bottom half of the tube 30 to lower layer 20. In this way, the tube 30 is completely sealed into the bag in two distinct stages.

On the first cycle, RF energy is applied to the closed tool (i.e. the upper and lower electrodes have been forced together by the air-operated press). The energy flows from the top electrode 110 (positive) to the lower electrode (negative). This acts to weld the bag perimeter and the top half of the tube 30.

Inserted in the tube 30 before it is placed in between the two layers 10, 20 is a mandrel 130. The mandrel is an elongate, generally cylindrical shaft, shaped to fit snugly inside the tube 30. In the second cycle, the tool stays in the closed position, as previously, but a change over is initiated. This means that a positive RF current is applied to the mandrel 130. No positive RF current is applied to the upper electrode 110 at this time.

Since the mandrel 130 is now positive compared to the lower electrode 120, the RF current passes through the lower half of tube 30, causing the lower half of the tube to heat up and weld to the lower sheet 20. The second cycle therefore completes the seal around the tube 30.

Although the double-cycle tooling operation described above is quicker than having to physically remove the device from the tool and flip it over, it is still more time consuming than a single cycle operation. Furthermore, it can result in an inconsistent seal, which may, in extreme circumstances, either leak or otherwise not conform to the required standard.

It is an aim of embodiments of the present invention to address shortcomings with prior art RF welding techniques and apparatus whether described herein or not.

According to a first aspect of the present invention, there is provided a mandrel for use in Radio Frequency (RF) welding, wherein the mandrel comprises first and second conductive portions separated by an insulating material, such that different potentials may be applied to the first and second conductive portions.

In one embodiment, the mandrel is an elongate member suitable for use in RF welding operations whereby a tube member is welded into a bag.

As used herein, the term ‘conductive portion’ refers to any material that readily conducts electric current through electrical conduction. These materials are well known to those skilled in the art and may, for example, include metallic and/or non-metallic conductors.

Thus the conductive portions may be formed from any of a number of conductive, heat-resistant metals. In one embodiment, the first and second conductive portions comprise a conductive, heat resistant metal. In a further embodiment, the first and second conductive portions comprise one or more metallic elements selected from copper, silver, aluminium, gold, tin/lead alloy, or brass. In a yet further embodiment, the first and second conductive portions comprise brass. Brass is advantageous because it has good electrical conductivity, good heat-transfer characteristics and it is easy to machine.

The insulating material should have good electrical insulating characteristics (i.e. a high resistance). Therefore as used herein, the term ‘insulating material’ refers to any material that blocks or retards the flow of electric current. The term is well known to those skilled in the art and includes all known dielectrics. In one embodiment, the insulating material is selected from one or more of anodized aluminium, ceramic, glass, glass ceramic, plastic, PolyTetraFluoroEthylene (PTFE) or Tufnol. In a further embodiment, the insulating material comprises a ceramic material.

It will be appreciated that the term ‘ceramic material’ refers to any industrially used material that is an inorganic, non-metallic solid. The structure and chemical ingredients, though various, result in universally recognised ceramic-like properties, in particular thermal and electrical conductivity considerably lower than that of metals. Typically, a ceramic is a metal oxide (that is, compounds of metallic elements and oxygen), but a ceramic (especially advanced ceramics) may comprise compounds of metallic elements and carbon, nitrogen, or sulphur. Examples of useful ceramics are alumina (aluminium oxide) and titania (titanium dioxide).

In one embodiment, the insulating material is held in position by the use of an adhesive and/or one or more pegs or dowels.

According to a second aspect of the present invention, there is provided an RF welding apparatus comprising an RF generator, a power applicator, a press and a mandrel, wherein the mandrel comprises first and second conductive portions separated by an insulating material, such that different potentials may be applied to the first and second conductive portions.

In one embodiment, the mandrel is the mandrel as hereinbefore defined.

In one embodiment, the RF generator comprises three main functional parts: a power supply; an oscillator; and a controller. The power supply is operable to convert an Alternating Current (AC) power supply to high-voltage (HV) Direct Current (DC). The oscillator acts to convert the HV DC signal into an AC signal at a particular voltage. Typically, the oscillator produces an output signal at 27.12 MHz (+/−0.6%) at a level of 1000 to 1500V. Other frequencies and output voltages are also used.

The controller is operable to regulate the output of the oscillator as the plastics material to be welded is heated. The controller is able to vary one or both of output power and duration of weld operation to achieve the desired result.

In one embodiment, the press is arranged to open and close the power applicator. In one embodiment, the press comprises a pedal operated press. In another embodiment, the press comprises an air operated press.

In a one embodiment, the power applicator comprises a first and second electrode, such that, in use, the first electrode is located adjacent the first portion of the mandrel and the second electrode is located adjacent the second portion of the mandrel. In a yet further embodiment, the first and second electrode may comprise a recess and be shaped and dimensioned to accommodate a tube.

According to a third aspect, there is provided a method of manufacturing a mandrel for use in Radio Frequency welding, comprising the steps of:

sandwiching an insulating material between two conductive materials to form a first part;
machining the resulting first part to remove excess material to form the mandrel.

In one embodiment, the method further includes the step of adding adhesive to secure the insulating material in place between the conductive materials.

Alternatively, or additionally, the method includes the step of securing the insulating material in place by the addition of at least one peg which is positioned through a hole in each of the conductive materials and the insulating material.

According to a fourth aspect of the present invention, there is provided a method of Radio Frequency (RF) welding a tube into a bag, formed from first and second layers of material, the tube being positioned between the layers of material, and the tube accommodating therein a mandrel, wherein the mandrel is arranged such that it comprises first and second distinct, electrically isolated portions, the method comprising the step of applying a first potential to a first portion of the mandrel and applying a second potential to a second portion of the mandrel.

In one embodiment, the method further includes the step of applying the second potential to a first electrode located adjacent the first portion of the mandrel and applying the first potential to a second electrode adjacent the second portion of the mandrel.

According to a fifth aspect of the present invention, there is provided use of a mandrel as hereinbefore defined for Radio Frequency (RF) welding a tube into a bag.

For a better understanding of the invention, and to show how embodiments of the same may be carried into effect, reference will now be made, by way of example, to the accompanying diagrammatic drawings in which:

FIG. 1 shows a prior art apparatus used to RF weld a tube into a bag;

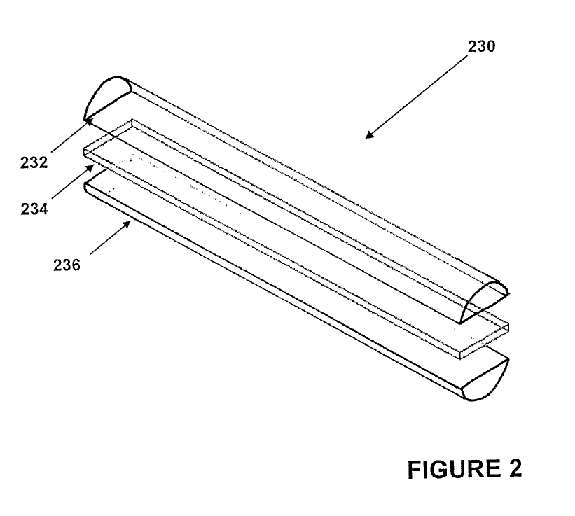

FIG. 2 shows an exploded perspective view of a mandrel forming an embodiment of the present invention;

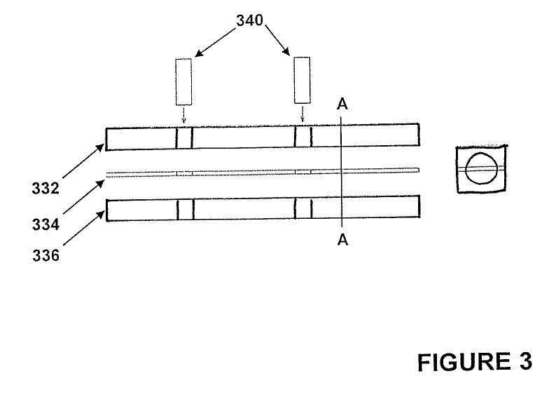

FIG. 3 shows how a mandrel according to an embodiment of 15 the present invention may be formed;

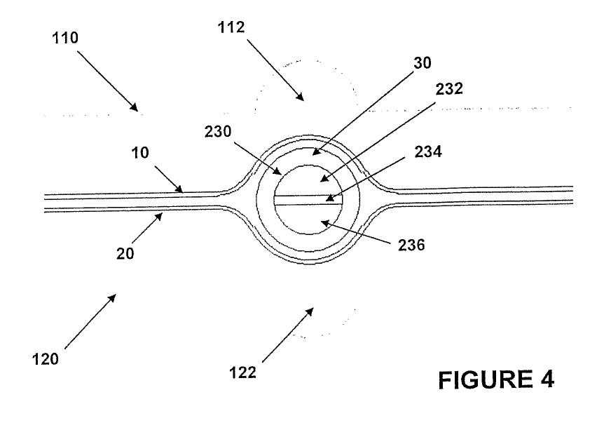

FIG. 4 shows a cross section through a mandrel forming an embodiment of the present invention in-situ in RF welding apparatus; and

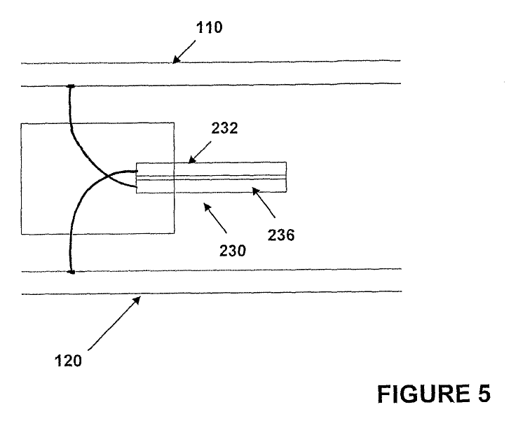

FIG. 5 shows schematically how a mandrel according to an embodiment of the present invention may be electrically connected.

FIG. 2 shows an exploded perspective view of a mandrel 230 forming an embodiment of the present invention. The mandrel 230 comprises three distinct portions: an upper conductive portion 232; an inner insulating portion 234; and a lower conducting portion 236.

The conductive portions 232, 236 may be formed from any of a number of conductive, heat-resistant metals, such as aluminium or brass. Brass is generally preferred due to its good electrical conductivity, good heat-transfer characteristics and it is easy to machine.

The insulating material should have good electrical insulating characteristics (i.e. a high resistance). A good choice is PTFE (PolyTetraFluoroEthylene), but other insulators may be used also. Another good choice is a ceramic material, such as alumina or titania.

The mandrel 230 may be formed in a number of different ways. One method involves cutting a solid cylindrical bar of conducting material along its length and sandwiching an insulating material between the two halves formed thereby. However, cutting a bar in this manner, it is relatively difficult to achieve a good clean cut and specialist equipment is required.

A preferred technique for producing a mandrel 230 is to begin with two equal over-sized brass bars 332, 336, which may be of any suitable cross-sectional shape. Rectangular or square cross-section is easy to work with.

A thin layer of heat-resistant, insulating material 334 (such as PTFE or a ceramic material, e.g. alumina or titania) is then placed between the two metal bars and held in place through the use of a suitable adhesive or resin or, preferably, through the use of one or more dowels or pegs 340 comprising a similar or identical insulating material. The pegs 340 are positioned to pass through suitable holes drilled or otherwise formed in the bars 332, 336 and insulation 334. The position of the holes and therefore the pegs 340 is selected so that they are not located in the immediate vicinity of where welding is to take place. The pegs 340 can be dimensioned to allow a tight interference fit and/or a suitable adhesive may be used.

The cross-sectional view of the completed bar along line A-A is shown on the right hand side of FIG. 3. The circular portion shown in this view represents the desired cross-sectional shape of the completed mandrel.

To remove the excess material from the rectangular cross-sectioned sandwich construction shown in FIG. 3, the part is placed in a lathe and turned to the desired shape and diameter. If a non-circular cross-section is required, then the part can be machined as necessary.

The end result of the machining process is a mandrel 230 according to an embodiment of the present invention.

An alternative method of manufacturing a mandrel according to an embodiment of the invention is to prepare each metallic portion of the mandrel separately and then sandwich a suitable insulating material between them.

In a mandrel formed from any of the above methods, the insulating material may be provided in a sheet form or may be sprayed or deposited on the metallic portions of the mandrel.

FIG. 4 shows how the mandrel 230 may be used in apparatus essentially the same as that used in the prior art to weld a tube into a bag in only a single cycle.

Instead of the prior art mandrel 130, the split mandrel 230 according to an embodiment of the present invention is inserted into the tube 30, which is then positioned between the two layers 10, 20 of plastics material.

Since the mandrel 230 is able to be simultaneously connected to two different potentials, it is possible to perform a welding operation which seals the tube 30 in position between the two layers 10, 20 in a single cycle. To achieve this, the upper electrode 110 is connected to a positive potential and the upper part 232 of the mandrel 230 is connected to a negative or earth potential. Likewise, the lower electrode 120 is connected to a negative or earth potential and the lower part 236 of the mandrel is connected to a positive potential.

This is shown in FIG. 5. This shows, schematically, how the upper electrode 110 is electrically connected to the lower part 236 of the mandrel 230. Also, the lower electrode 120 is electrically connected to the upper part 232 of mandrel 230. The insulating material 234, positioned between the upper 232 and lower 236 parts of mandrel 230 prevents a DC short circuit between the positive and negative potentials of the RF circuit.

In this configuration, it can be seen that application of a positive potential to the upper electrode 110 and the lower portion 236 of the mandrel, and the application of a negative or earth potential to the lower electrode 120 and upper portion 232 of the mandrel creates a situation where an RF current flow is created so that both upper and lower halves of the tube 30 may be RF welded to the upper and lower layers 10, 20 of the bag in a single operation.

Embodiments of the present invention can be easily retrofitted to existing RF welding apparatus, with only minimal adaptation to the mandrel connection being required.

The resulting products can be produced in a shorter time and to a more consistent standard, resulting in a more economic and higher quality process.

In some circumstances, it may be desirable to provide a mandrel having a cross-section other than a circular one. By manufacturing it from differently shaped and/or dimensioned source materials and/or machining it differently, a range of different shapes, cross-sections or profiles can be achieved.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A mandrel for use in Radio Frequency (RF) welding, wherein the mandrel comprises first and second conductive portions separated by an insulating material, such that different potentials may be applied to the first and second conductive portions.

2. A mandrel as claimed in claim 1 wherein the mandrel is an elongate member suitable for use in RF welding operations whereby a tube member is welded between two layers of sheet material.

3. A mandrel as claimed in claim 1 wherein the first and second conductive materials comprise brass.

4. A mandrel as claimed in claim 1 wherein the insulating material comprises PolyTetraFluoroEthylene (PTFE).

5. A mandrel as claimed in claim 1 wherein the insulating material comprises a ceramic material.

6. A mandrel as claimed in claim 1 wherein the insulating material is retained in position by use of an adhesive.

7. A mandrel as claimed in claim 1 wherein the insulating material is retained in position by use of at least one peg.

8. Use of a mandrel as defined in claim 1 for Radio Frequency (RF) welding a tube into a bag.

9. An RF welding apparatus comprising an RF generator, a power applicator, a press and a mandrel, wherein the mandrel is as defined in claim 1.

10. A method of Radio Frequency (RF) welding a tube into a bag, formed from first and second layers of material, the tube being positioned between the layers of material, and the tube accommodating therein a mandrel, wherein the mandrel is arranged such that it comprises first and second distinct, electrically isolated portions, the method comprising the step of applying a first potential to a first portion of the mandrel and applying a second potential to a second portion of the mandrel.

11. A method as claimed in claim 10 further comprising the step of applying the second potential to a first electrode located adjacent the first portion of the mandrel and applying the first potential to a second electrode adjacent the second portion of the mandrel.

12. A method as claimed in claim 10 further comprising the step of bringing the first and second electrodes into contact with the layers to be welded.

13. A method of manufacturing a mandrel for use in Radio Frequency (RF) welding, comprising the steps of:
sandwiching an insulating material between two conductive materials to form a first part;
machining the resulting first part to remove excess material to form the mandrel.

14. A method as claimed in claim 13, wherein the method further includes the step of adding adhesive to secure the insulating material in place between the conductive materials.

15. A method as claimed in claim 13, wherein the method further includes the step of securing the insulating material in place by the addition of at least one peg which is positioned through a hole in each of the conductive materials and the insulating material.
